(19) United States
(12) Patent Application Publication
(10) Pub. No.: US 2010/0236207 A1
(43) Pub. Date: Sep. 23, 2010

(54) SLURRY TRANSPORT SYSTEM FOR FORAGE HARVESTER

(75) Inventor: Timothy J. Kraus, Blakesburg, IA (US)

Correspondence Address: BAKER & DANIELS LLP/DEERE & COMPANY, 300 NORTH MERIDIAN STREET, SUITE 2700, INDIANAPOLIS, IN, 46204, US

(73) Assignee: DEERE & COMPANY, Moline, IL (US)

(21) Appl. No.: 12/409,075

(22) Filed: Mar. 23, 2009

(51) Int. Cl. A01D 57/00; B60P 1/60

(52) U.S. Cl. 56/16.4 R; 406/39

(57) ABSTRACT

A continuous flow transport system is disclosed for transporting harvested crops from a forage harvester to a processing plant in a slurry form.

### FIELD OF THE INVENTION

The present disclosure relates to agricultural vehicles. More particularly, the present disclosure relates to a system for transporting harvested materials from agricultural vehicles.

### BACKGROUND OF THE INVENTION

A forage harvester is an agricultural vehicle that harvests forage crops, such as corn, grass, and other plants, and chops the crops into small pieces. Typically, the forage harvester blows the chopped crops out a chute and into a truck, a tractor, a wagon, or another vehicle, traveling alongside the forage harvester. The truck or other vehicle collects the chopped crops from the forage harvester and delivers its load to a processing plant, where the chopped crops may be fermented or otherwise processed to provide biofuels, feed for livestock, or other products.

### SUMMARY

The present disclosure provides a continuous flow transport system for transporting harvested crops from a forage harvester to a processing plant in a slurry form.

According to an embodiment of the present disclosure, an agricultural vehicle is provided. The agricultural vehicle includes a chassis, at least one ground engaging mechanism configured to propel the chassis over a field, a crop harvesting assembly configured to gather at least one crop from the field, a fluid inlet configured to receive a fluid, a slurry outlet, and a mixing chamber in communication with the fluid inlet, the crop harvesting assembly, and the slurry outlet, the mixing chamber being configured to receive the fluid from the fluid inlet and the at least one crop from the crop harvesting assembly.

According to another embodiment of the present disclosure, an agricultural harvesting system is provided. The agricultural harvesting system includes an agricultural vehicle configured to traverse a field and to gather at least one crop from the field to produce a harvested crop. The agricultural harvesting system also includes a processing plant, a fluid delivery system configured to deliver a fluid to the agricultural vehicle, and a slurry return system configured to deliver the harvested crop and the fluid from the agricultural vehicle to the processing plant.

According to yet another embodiment of the present disclosure, a method of harvesting crops is provided. The method includes the steps of operating an agricultural vehicle to gather at least one crop from a field; mixing the at least one crop with a fluid to produce a slurry; and directing the slurry from the vehicle to a processing plant.

### BRIEF DESCRIPTION OF THE DRAWINGS

The above-mentioned and other features and advantages of this disclosure, and the manner of attaining them, will become more apparent and the disclosure itself will be better understood by reference to the following description of embodiments of the invention taken in conjunction with the accompanying drawings, wherein:

FIG. 1 is an elevational view of an embodiment of a forage harvester, and

FIG. 2 is a schematic diagram illustrating an exemplary slurry transport system of the present disclosure, including the forage harvester of FIG. 1.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

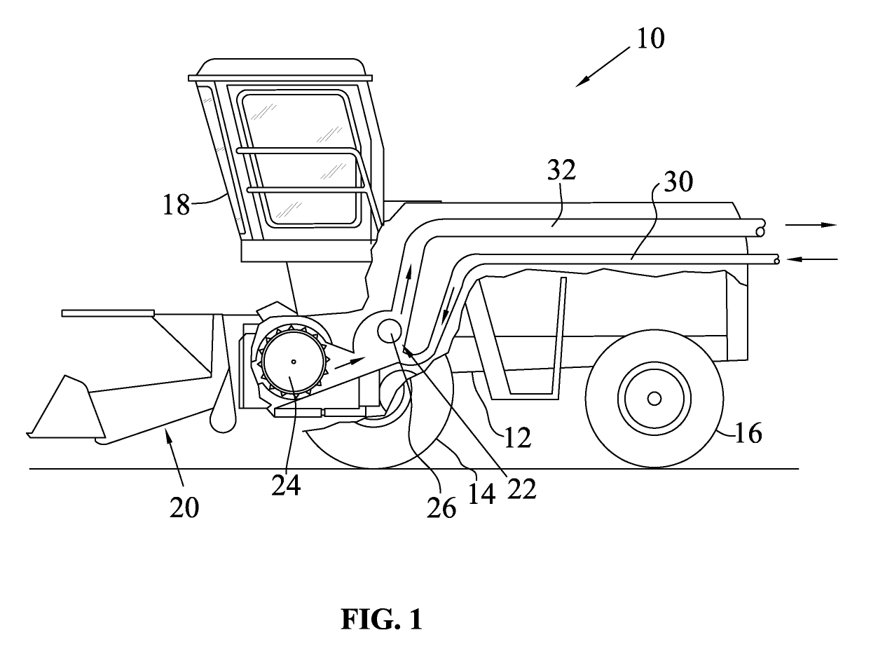

Referring to FIG. 1, an agricultural vehicle in the form of a self-propelled forage harvester 10 is illustrated. Although forage harvester 10 is illustrated and described herein as a self-propelled vehicle, forage harvester 10 may be coupled to another vehicle, such as a tractor, to propel forage harvester 10. Forage harvester 10 includes chassis 12 and a ground engaging mechanism capable of supporting chassis 12 and propelling chassis 12 across the ground. In the illustrated embodiment, forage harvester 10 includes ground engaging mechanisms in the form of a pair of front wheels 14 and a pair of rear wheels 16 capable of supporting chassis 12 and propelling chassis 12 across the ground.

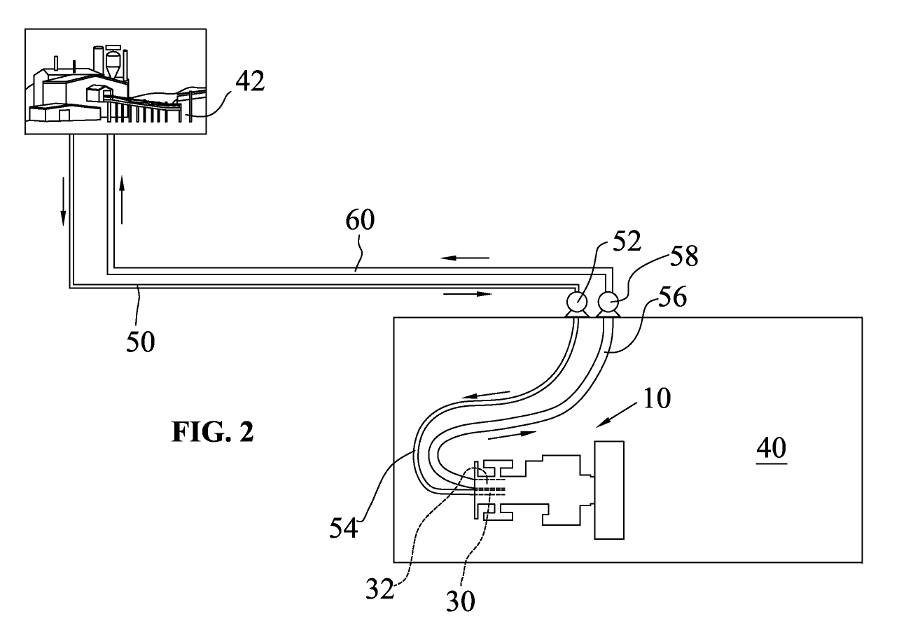

Forage harvester 10 also includes operator cab 18 that is provided with necessary controls (not shown) to operate forage harvester 10. From operator cab 18, the operator can visually observe a front-mounted crop harvesting assembly 20. In use, crop harvesting assembly 20 gathers forage crops, such as corn, grass, and other plants, from field 40 (FIG. 2). The gathered or harvested crops are directed from crop harvesting assembly 20 of forage harvester 10 toward a suitable fragmenting assembly, such as cutterhead 24. Cutterhead 24 rotates to cut the harvested crops into small pieces. A known cutterhead is disclosed in U.S. Pat. No. 7,213,781, the disclosure of which is expressly incorporated herein by reference. The fragmenting assembly may also include a suitable grinder, press, grate, or blender, for example, that is capable of separating the harvested crops into small pieces.

To remove the harvested and chopped crops from forage harvester 10, forage harvester 10 includes mixing chamber 22, fluid inlet 30, and slurry outlet 32. Forage harvester 10 may also include discharge pump 26, as shown in FIG. 1. In operation, chopped crops exiting cutterhead 24 are directed into mixing chamber 22. Also, a suitable fluid is directed via fluid inlet 30 into mixing chamber 22. The fluid may include a neutral fluid, such as water, an acidic fluid, or a basic fluid, for example. According to an exemplary embodiment of the present disclosure, the fluid is directed into mixing chamber 22 downstream of cutterhead 24 and at least partially upstream of discharge pump 26. The incoming fluid from fluid inlet 30 mixes with the chopped crops exiting cutterhead 24 in mixing chamber 22 to produce a pumpable slurry. If the fluid includes an acidic fluid or a basic fluid, for example, the chopped crops may undergo pretreatment at this stage, even before reaching processing plant 42 (FIG. 2). It is also within the scope of the present disclosure that the fluid may include a suitable additive to begin pretreating the chopped crops, such as an enzyme, an inoculant, or another biologically active agent, for example.

Next, discharge pump 26 directs the slurry out of mixing chamber 22 of forage harvester 10 via slurry outlet 32. According to an exemplary embodiment of the present disclosure, discharge pump 26 is located inside mixing chamber 22 of forage harvester 10, and the fluid is directed via fluid inlet 30 into mixing chamber 22 as the slurry enters or travels through discharge pump 26. It is also within the scope of the present disclosure that discharge pump 26 may be located outside of mixing chamber 22 or outside of forage harvester 10 altogether while still being able to direct the slurry out of mixing chamber 22.

Referring next to FIG. 2, forage harvester 10 is schematically illustrated gathering and chopping crops in field 40. The crops may be delivered from forage harvester 10 to processing plant 42 for storage, compaction, fermentation, or other processing. Rather than transporting the chopped crops in batches to processing plant 42 via trucks or tractors that travel alongside forage harvester 10, the present disclosure provides a continuous flow transport system 44 for transporting the chopped crops from forage harvester 10 to processing plant 42 in a slurry form.

An exemplary transport system 44 includes fluid delivery system 46 and slurry return system 48. As shown in FIG. 2, fluid delivery system 46 of transport system 44 includes main fluid line 50, fluid boost pump 52, and flexible fluid line 54. Slurry return system 48 of transport system 44 includes flexible slurry line 56, slurry boost pump 58, and main slurry line 60.

In operation, a suitable fluid, such as water, is delivered from processing plant 42 or another suitable fluid source to forage harvester 10 operating in field 40 via fluid delivery system 46 of transport system 44. As shown in FIG. 2, the fluid is directed from processing plant 42 via main fluid line 50. Main fluid line 50 may be a stationary fluid line that extends from processing plant 42 to an outer edge of field 40. Then, the fluid traveling through main fluid line 50 encounters fluid boost pump 52. Fluid boost pump 52 may be a stationary pump located at an outer edge of field 40. Fluid boost pump 52 then delivers the fluid through flexible fluid line 54 to fluid inlet 30 of forage harvester 10. Flexible fluid line 54 is configured to travel along with forage harvester 10 while driving across field 40. For example, flexible fluid line 54 may be a flexible hose.

As discussed above, the fluid entering fluid inlet 30 of forage harvester 10 is mixed with chopped crops to produce a pumpable slurry. The slurry exits forage harvester 10 from slurry outlet 32 and is returned to processing plant 42 via slurry return system 48 of transport system 44. Flexible slurry line 56 is coupled to slurry outlet 32 of forage harvester 10. Like flexible fluid line 54, flexible slurry line 56 is configured to travel along with forage harvester 10 while driving across field 40. For example, flexible slurry line 56 may be a flexible hose. The slurry travels through flexible slurry line 56 and encounters slurry boost pump 58. Slurry boost pump 58 may be a stationary pump located at an outer edge of field 40. In the illustrated embodiment of FIG. 2, slurry boost pump 58 is located adjacent to fluid boost pump 52 near an outer edge of field 40. Slurry boost pump 58 then delivers the slurry through main slurry line 60 to processing plant 42. Main slurry line 60, like main fluid line 50, may be a stationary fluid line that extends from an outer edge of field 40 to processing plant 42.

To accommodate the chopped crops in the slurry, the components of slurry return system 48, which are configured to return both the chopped crops and the fluid to processing plant 42, may have a larger capacity than the components of fluid delivery system 46, which are configured to deliver fluid to forage harvester 10. For example, main slurry line 60 may have a larger capacity than main fluid line 50; slurry boost pump 58 may have a larger capacity than fluid boost pump 52; and flexible slurry line 56 may have a larger capacity than flexible fluid line 54. Alternatively, the corresponding components fluid delivery system 46 and slurry return system 48 may be substantially the same. For example, main slurry line 60 may be substantially the same as main fluid line 50; slurry boost pump 58 may be substantially the same as fluid boost pump 52; and flexible slurry line 56 may be substantially the same as flexible fluid line 54.

When the slurry reaches processing plant 42, the fluid and chopped crops may be separated, if necessary. The fluid and chopped crops may be separated using filtration with a vibrating screen, centrifugation, heated drying, or another suitable separation process. After the fluid is removed, the chopped crops may be stored, compacted, fermented, or otherwise processed, in processing plant 42 to produce biofuels, feed for livestock, or other products. The fluid that is separated from the chopped crops may be directed to main fluid line 50 and recycled through the system.

Transport system 44 of the present disclosure may eliminate the need for trucks or tractors that travel alongside forage harvester 10 to collect and deliver chopped crops in batches to processing plant 42. As crop production increases, the number and/or frequency of trucks driving back and forth from field 40 to processing plant 42 may also increase. These batch delivery trucks are associated with significant capital costs, labor costs, fuel costs, and equipment maintenance costs. Also, the truck traffic may undesirably compact the soil of field 40 and may increase road maintenance costs. Therefore, by eliminating batch delivery trucks, transport system 44 of the present disclosure may reduce capital costs, labor costs, fuel costs, equipment maintenance costs, soil compaction, and road maintenance costs.

Also, transport system 44 of the present disclosure may increase the efficiency and capacity of the forage harvesting process. For example, the continuous flow transport system 44 described above may allow forage harvester 10 to operate continuously, without having to stop operations between each new batch delivery truck.

While this invention has been described as having preferred designs, the present invention can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this invention pertains and which fall within the limits of the appended claims.

1. An agricultural vehicle including:
a chassis;
at least one ground engaging mechanism configured to propel the chassis over a field;
a crop harvesting assembly configured to gather at least one crop from the field;
a fluid inlet configured to receive a fluid;
a slurry outlet; and
a mixing chamber in communication with the fluid inlet, the crop harvesting assembly, and the slurry outlet, the mixing chamber being configured to receive the fluid from the fluid inlet and the at least one crop from the crop harvesting assembly.

2. The agricultural vehicle of claim 1, further including a pump configured to direct the at least one crop and the fluid from the mixing chamber via the slurry outlet.

3. The agricultural vehicle of claim 2, wherein the pump is positioned in the mixing chamber.

4. The agricultural vehicle of claim 1, further including a fragmenting assembly configured to separate the at least one crop into pieces, wherein the fragmenting assembly is positioned in communication with the mixing chamber.

5. The agricultural vehicle of claim 4, wherein the fluid inlet is positioned to deliver the fluid to the at least one crop downstream of the fragmenting assembly.

6. The agricultural vehicle of claim 1, wherein the fluid includes at least one of water, an acidic fluid, and a basic fluid.

7. The agricultural vehicle of claim 1, wherein the fluid includes an additive.

8. The agricultural vehicle of claim 1, wherein the fluid inlet of the agricultural vehicle is coupled to a flexible fluid line.

9. The agricultural vehicle of claim 1, wherein the slurry outlet of the agricultural vehicle is coupled to a flexible slurry line.

10. An agricultural harvesting system including:
an agricultural vehicle configured to traverse a field and to gather at least one crop from the field to produce a harvested crop;
a processing plant;
a fluid delivery system configured to deliver a fluid to the agricultural vehicle; and
a slurry return system configured to deliver the harvested crop and the fluid from the agricultural vehicle to the processing plant.

11. The agricultural harvesting system of claim 10, wherein the agricultural vehicle includes:
a fluid inlet configured to receive the fluid from the fluid delivery system; and
a slurry outlet configured to direct the harvested crop and the fluid to the slurry return system.

12. The agricultural harvesting system of claim 11, wherein the agricultural vehicle further includes a mixing chamber that communicates with the fluid inlet and the slurry outlet.

13. The agricultural harvesting system of claim 12, wherein the agricultural vehicle further includes a pump positioned in the mixing chamber.

14. The agricultural harvesting system of claim 13, wherein the fluid inlet is positioned to deliver the fluid to the mixing chamber upstream of the pump.

15. The agricultural harvesting system of claim 10, wherein the fluid delivery system includes at least one fluid boost pump configured to deliver the fluid to the agricultural vehicle.

16. The agricultural harvesting system of claim 10, wherein the slurry return system includes at least one slurry boost pump configured to deliver the harvested crop and the fluid from the agricultural vehicle to the processing plant.

17. The agricultural harvesting system of claim 10, wherein the fluid delivery system includes a flexible fluid line coupled to the agricultural vehicle and configured to travel with the agricultural vehicle while the agricultural vehicle traverses the field.

18. The agricultural harvesting system of claim 10, wherein the slurry return system includes a flexible slurry line coupled to the agricultural vehicle and configured to travel with the agricultural vehicle while the agricultural vehicle traverses the field.

19. The agricultural harvesting system of claim 10, further including a separator configured to separate the fluid from the harvested crop.

20. The agricultural harvesting system of claim 19, wherein the separator is coupled to the fluid delivery system to return the separated fluid to the agricultural vehicle.

21. A method of harvesting crops including the steps of:
operating an agricultural vehicle to gather at least one crop from a field;
mixing the at least one crop with a fluid to produce a slurry; and
directing the slurry from the vehicle to a processing plant.

22. The method of claim 21, wherein the directing step includes pumping the slurry from the vehicle via a discharge pump, and the mixing step includes mixing the at least one crop with the fluid upstream of the discharge pump.

23. The method of claim 21, wherein the directing step includes directing the slurry through a flexible slurry line configured to travel with the agricultural vehicle during the operating step.

24. The method of claim 21, wherein the directing step includes directing the slurry through at least one slurry boost pump configured to deliver the slurry to the processing plant.

25. The method of claim 21, further including the steps of:
separating the fluid from the slurry; and
returning the separated fluid to the agricultural vehicle.
